(19) United States
(12) Patent Application Publication
(10) Pub. No.: US 2012/0316777 A1
(43) Pub. Date: Dec. 13, 2012

(54) PORTABLE TERMINAL, NAVIGATION SYSTEM, AND STORAGE MEDIUM STORING PROGRAM

(75) Inventor: Noriyuki KITTA, Tokyo (JP)

(73) Assignee: CASIO COMPUTER CO., LTD., Tokyo (JP)

(21) Appl. No.: 13/487,798

(22) Filed: Jun. 4, 2012

(30) Foreign Application Priority Data
Jun. 7, 2011 (JP) 2011-126855

(51) Int. Cl. G01C 21/36

(52) U.S. Cl. 701/431

(57) ABSTRACT

A portable terminal includes: a wireless communication unit which performs transmission and reception of data with a portable external instrument by wireless communication; a control unit which requests navigation data from the portable external instrument at a previously set request timing to obtain the navigation data therefrom; a display unit which performs a display based on a control signal from the control unit; and a detection unit which detects an orientation, wherein the control unit (i) allows the display unit to display orientation information included in the navigation data, in accordance with orientation data obtained based on a signal from the detection unit, and (ii) allows the display unit to display navigation data including at least a display in a travelling direction, that is simple in comparison with the navigation data displayed by the portable external instrument, based on the navigation data obtained from the portable external instrument.

### CROSS-REFERENCE TO RELATED APPLICATIONS

This application is based upon and claims the benefit of priority from the prior Japanese Patent Application No. 2011-126855, filed on Jun. 7, 2011, the entire contents of which are incorporated herein by reference.

### BACKGROUND OF THE INVENTION

1. Field of the Invention

The present invention relates to a portable terminal for use in navigation, to a navigation system, and to a storage medium storing a program.

2. Description of Related Art

Heretofore, there has been a navigation device that guides a course of a user to a destination thereof by map data and positioning data obtained by using a satellite-using positioning system such as a global positioning system (GPS). The navigation device as described above includes a portable navigation device usable by a pedestrian.

For example, in Japanese Patent Laid-Open Publication No. 2008-286546, a technology is disclosed, in which, in a watch having a function to receive GPS data, a region of the watch, the region corresponding to a movement direction of the user, is vibrated based on positioning data, map data and data of an attitude sensor, whereby the user is informed of the movement direction through the sense of touch. Moreover, in Japanese Patent Laid-Open Publication No. 2008-286547, a technology is disclosed, in which, in the watch having the function to receive the GPS data, a weight and a turntable are further provided, and the weight and the turntable are operated so as to generate centrifugal force in the movement direction of the user, whereby the user is navigated. Furthermore, in Japanese Patent Laid-Open Publication No. H10-332407 (published in 1998), a technology is described, in which, in a navigation device for a pedestrian, the navigation device having a GPS function and a function to detect the movement direction by a gyro function, in a case where the user moves in a direction different from a guiding direction, a vibrator is vibrated, whereby the user is guided in such a correct movement direction.

Meanwhile, as a technology related to the invention of this application, in Japanese Patent Laid-Open Publication No. 2010-268330, a technology is disclosed, in which a case where it is difficult to see a navigation screen of the navigation device owing to the ambient environment, a case where it is difficult to hear a notification sound owing thereto, and so on, are sensed by a light quantity sensor, a noise sensor and the like, and the watch is made to temporarily act for the navigation device in terms of the function.

However, the conventional portable navigation device has been a device that is premised to be used by being held by the user's hand. Hence, in a case where a user who rides a bicycle, a pedestrian who carries baggage, or the like desires to use a navigation device, then the conventional portable navigation device cannot be held easily since there is no free hand, and accordingly, it has sometimes been difficult to use the portable navigation device concerned. Meanwhile, heretofore, in the navigation device mounted on the watch, it has been difficult to frequently receive the data owing to such a problem of a battery capacity, and accordingly, in some cases, the navigation device concerned has not been able to obtain sufficient positioning data, and has not been able to achieve the navigation function satisfactorily.

The present invention provides a potable terminal, a navigation system, and storage medium storing a program, each of which enables the user to easily obtain the necessary navigation information while suppressing large power consumption.

### SUMMARY OF THE INVENTION

According to an aspect of the present invention, there is provided a portable terminal comprising:

a wireless communication unit which performs transmission and reception of data with a portable external instrument by wireless communication;

a control unit which requests navigation data from the portable external instrument at a previously set request timing, and obtains the navigation data from the portable external instrument by using the wireless communication unit; and

a display unit which performs a display based on a control signal from the control unit, and

a detection unit which detects an orientation,

wherein the control unit (i) allows the display unit to display orientation information included in the navigation data obtained from the wireless communication unit, in accordance with orientation data obtained based on a signal from the detection unit, and (ii) allows the display unit to display navigation data that is simple in comparison with the navigation data displayed by the portable external instrument, the simple navigation data including at least a display in a travelling direction, based on the navigation data obtained from the portable external instrument by the wireless communication unit.

According to another aspect of the present invention, there is provided a storage medium which stores a program which allows a computer, including a wireless communication unit performing transmission and reception of data with a portable external instrument by wireless communication; a display unit; and a detection unit which detects an orientation, to function as:

a control unit which requests navigation data from the portable external instrument at a previously set request timing, and obtains the navigation data from the portable external instrument by using the wireless communication unit,

wherein the control unit executes processing for (i) allowing the display unit to display orientation information included in the navigation data obtained from the wireless communication unit, in accordance with orientation data obtained based on a signal from the detection unit, and (ii) allowing the display unit to display navigation data that is simple in comparison with the navigation data displayed by the portable external instrument, the simple navigation data including at least a display in a travelling direction, based on the navigation data obtained from the portable external instrument by the wireless communication unit.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is an overall configuration view showing a navigation system of an embodiment of the present invention;

FIG. 2 is a block diagram showing an internal configuration of an electronic timepiece;

FIG. 3 is a block diagram showing an internal configuration of a cellular phone;

FIG. 4 is a sequence chart showing a procedure of communication to be performed between the cellular phone and the electronic timepiece;

FIGS. 5A and 5B are sequence charts showing procedures of communication to be performed between the cellular phone and the electronic timepiece in a case where the cellular phone fails to receive radio waves from GPS satellites;

FIG. 6 is a flowchart showing a control procedure of watch navigation processing by a CPU of the electronic timepiece;

FIGS. 7A to 7C show display examples on a display unit of the electronic timepiece in a watch navigation mode; and

FIG. 8 is a flow chart showing a procedure of control to be executed by the CPU in an event of navigation data obtaining processing.

### DETAILED DESCRIPTION OF THE PREFERRED EMBODIMENT

A description is made below of a navigation system in an embodiment of the present invention based on the drawings.

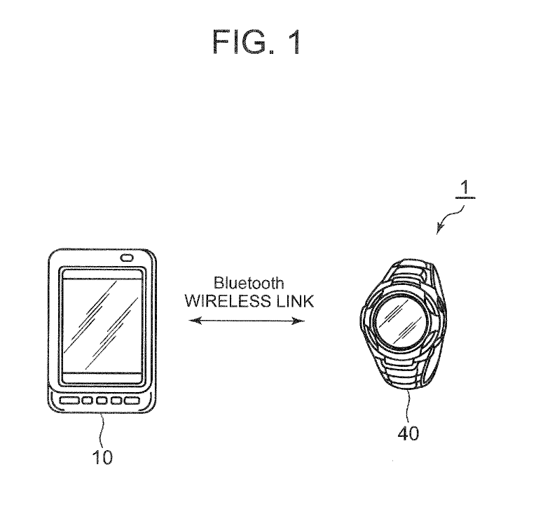

FIG. 1 is an overall configuration view showing the navigation system of this embodiment.

The navigation system 1 of this embodiment is composed of: an electronic timepiece 40 as a wrist-attached terminal (portable terminal); and a cellular phone 10 as a portable external instrument. The electronic timepiece 40 is one of a watch type, which includes a watch body and a band, and is attachable to the wrist. The cellular phone 10 includes a wireless communication function to perform wireless communication with a base station, and in addition, a function to receive radio waves from GPS satellites. As a single body, the cellular phone 10 is capable of executing GPS positioning and a navigation operation with regard to a travelling direction of a user. Moreover, each of the electronic timepiece 40 and the cellular phone 10 includes a short-range wireless communication function, and is capable of mutual communication with other by, for example, Bluetooth (registered trademark) communication.

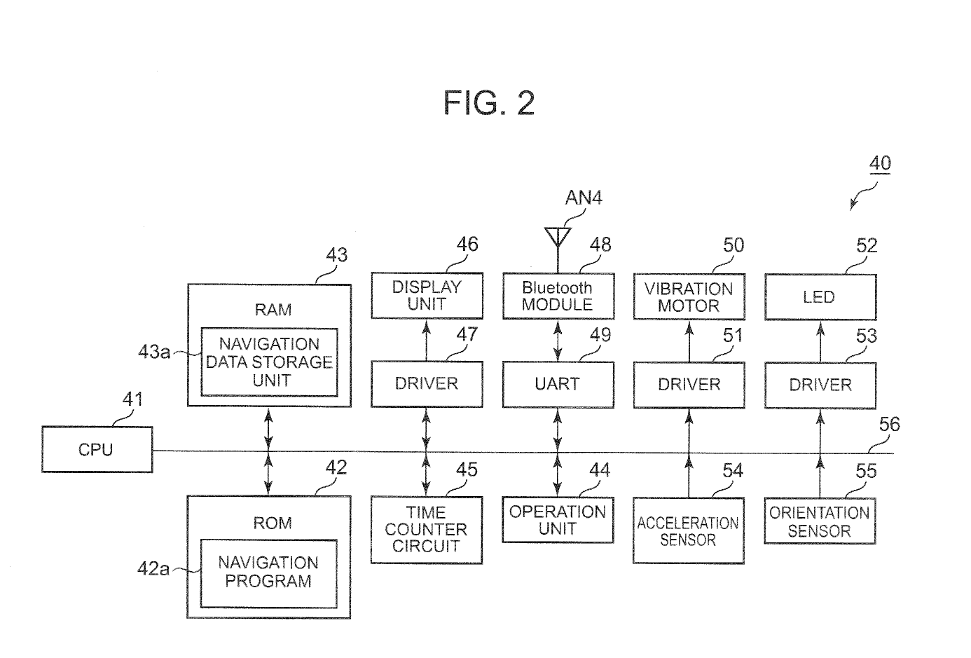

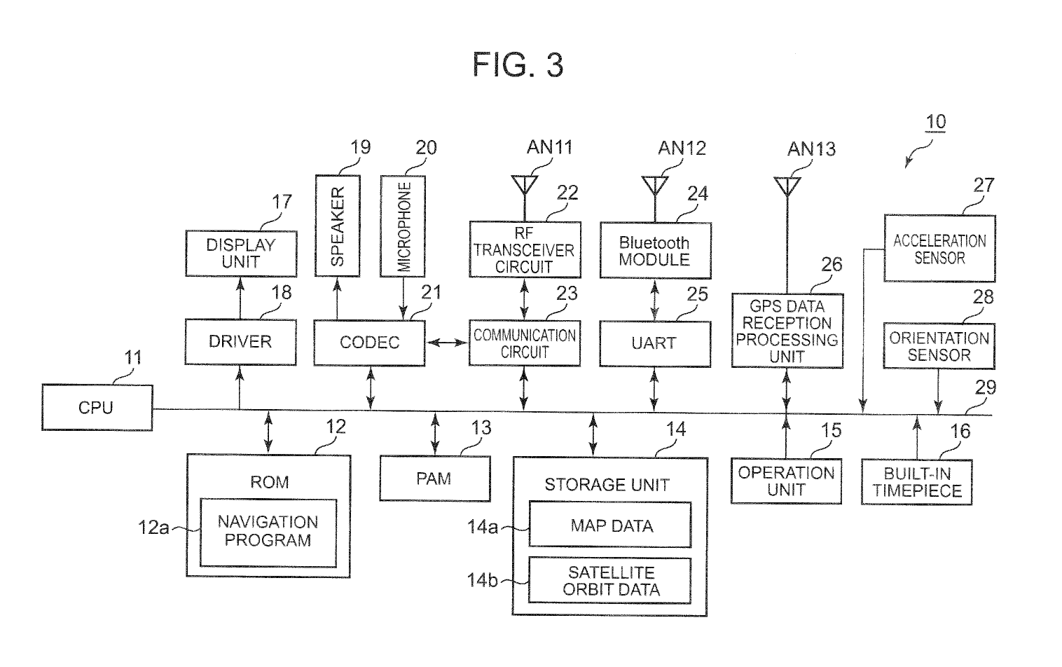

FIG. 2 is a block diagram showing an internal configuration of the electronic timepiece of this embodiment. Moreover, FIG. 3 is a block diagram showing an internal configuration of the cellular phone of this embodiment.

As shown in FIG. 2, the electronic timepiece 40 includes: a central processing unit (CPU) 41 (control unit); a read only memory (ROM) 42; a random access memory (RAM) 43; an operation unit 44 (operation unit); a time counter circuit 45; a display unit 46 (display unit) and a driver 47 that controls drive of the display unit 46; a Bluetooth module 48 (wireless communication unit) and a universal asynchronous receiver transmitter (UART) 49; a vibration motor 50 and a driver 51 thereof; a light emitting diode (LED) 52 and a driver 53 thereof; an acceleration sensor 54; an orientation sensor 55 as a detection unit; a bus 56 that transfers signals between the CPU 41 and the respective units.

The CPU 41 performs centralized control for the entire operations of the electronic timepiece 40 and a variety of arithmetic operation processing. The CPU 41 allows the display unit 46 to perform time display based on a current time to be counted by the time counter circuit 45. Moreover, the CPU 41 executes a navigation program 42a, and allows the display unit 46 to display simple navigation data that is based on navigation data obtained from the cellular phone 10 through the Bluetooth module 48. In addition, the CPU 41 calculates an attitude of the electronic timepiece 40 and a movement direction and movement speed of the user based on output signals from the acceleration sensor 54 and the orientation sensor 55.

The ROM 42 stores a variety of programs to be executed by the CPU 41, and stores initial setting data. Such data to be stored in the ROM 42 includes the navigation program 42a. The CPU 41 executes this navigation program 42a, whereby, in place of the cellular phone 10, it becomes possible to allow the display unit 46 of the electronic timepiece 40 to display the navigation data.

The RAM 43 provides a working memory space to the CPU 41. Moreover, the RAM 43 includes a navigation data storage unit 43a. The navigation data storage unit 43a temporarily stores information, which is obtained from the cellular phone 10 through the Bluetooth module 48, and is necessary in the event of displaying the navigation data on the display unit 46.

The operation unit 44 includes one or plural keys, and creates an input signal based on an operation which the user performs for the keys concerned, and outputs the created input signal to the CPU 11. Alternatively, this operation unit 44 may be a touch panel.

The time counter circuit 45 is a counter that counts and holds the current time. This current time is read out, and is then displayed on the display unit 46. Moreover, data of the current time concerned and setting time data related to a variety of functions are compared with each other, whereby a variety of functions are performed, and so on.

The display unit 46 is, for example, a liquid crystal display (LCD). By a control signal sent from the CPU 41, the driver 47 (liquid crystal driver) operates, and allows the LCD to make display regarding the current time, a setting state, or designated contents such as a menu of the various functions. Alternatively, this display unit 46 may be another display unit, for example, an organic electro-luminescent display (ELD), and the driver 47 is selected as appropriate depending on a type of the display unit 46.

On this display unit 46, it is possible to display numbers and letters of a date, a time and the like by the dot matrix display. In addition, it is also possible to allow the display unit 46 to perform analog display by displaying indicators on the LCD. Moreover, the display mode is switched from a time mode to a watch navigation mode, whereby it is possible display, by numbers and letters, a movement distance and a movement direction in the event of performing the navigation, and in addition, it is possible to display the travelling direction by an indicator. Moreover, according to needs, this display unit 46 can also display a peripheral map simplified to a road on which the user is moving and a road intersecting the road concerned.

The Bluetooth module 48 is a control module for performing Bluetooth communication with an external instrument through an antenna AN4. Transmission data sent from the CPU 41 is subjected to processing such as serial/parallel conversion by the UART 49, and is transmitted to the external instrument from the Bluetooth module 48. Moreover, reception data received from the external instrument by using the Bluetooth module 48 is subjected to processing such as the serial/parallel conversion by the UART 49, and is outputted to the CPU 41.

The vibration motor 50 and the light emitting diode (LED) 52 are those for issuing a notice to the user by vibrating and emitting light. When control signals are sent individually to the drivers 51 and 53 from the CPU 41, then the drivers 51 and 53 convert the control signals into voltage signals necessary to operate the vibration motor 50 and the LED 52, and output the voltage signals concerned.

The acceleration sensor 54 is a semiconductor sensor capable of detecting accelerations in three axis directions. Based on output data of this acceleration sensor 54, a gravitational acceleration direction, that is, a downward direction, and the traveling direction are specified.

The orientation sensor 55 is, for example, a three-axis geomagnetic sensor using a magnetoresistive element. Based on an output of this orientation sensor 55, the CPU 41 can grasp the travelling direction of the user and the attitude of the electronic timepiece 40.

As shown in FIG. 3, the cellular phone 10 includes: a CPU 11 (navigation data creation unit, movement vector calculation unit); a ROM 12; a RAM 13; a storage unit 14; an operation unit 15 (input unit); a built-in timepiece 16; a display unit 17 and a driver 18 thereof; a speaker 19; a microphone 20; a codec 21; an RF transceiver circuit 22; an antenna AN11 for RF transmission/reception; a communication circuit 23; a Bluetooth module 24 (external wireless communication unit); an UART 25; an antenna AN12 for transmission/reception of the Bluetooth communication; a GPS data reception processing unit 26 (positioning data receiving unit); an antenna AN13 for receiving radio waves transmitted from the GPS satellites; an acceleration sensor 27; an orientation sensor 28; a bus 29 that connects the CPU 11 and the respective units to each other; and the like.

The CPU 11 performs centralized control for the entire operations of the cellular phone 10 and a variety of arithmetic operation processing. The CPU 11 sends a control signal to the GPS data reception processing unit 26 at the time of executing the navigation, and allows the GPS data reception processing unit 26 to receive GPS satellite data and obtain position data, and in addition, decides a course and the travelling direction based on the obtained position data and on map data stored in the storage unit 14, thereby creating the navigation data. For example, the navigation data may include route information toward a destination. Then, the CPU 11 sends this navigation data to the driver 18, and allows the display unit 17 to display the navigation data concerned. Moreover, based on an input operation to the operation unit 15, the CPU 11 discontinues such a navigation data display command issued to the driver 18, and in addition, sends a control signal to the Bluetooth module 24, and then allows the Bluetooth module 24 to transmit the navigation data to the electronic timepiece 40.

Furthermore, the CPU 11 estimates the movement direction and the movement distance based on outputs of the acceleration sensor 27 and the orientation sensor 28, which will be described later, and adds a movement vector thus calculated to the position data taken as a reference, thereby being capable of obtaining a current position (by autonomous navigation). In the case where the radio waves from the GPS satellites cannot be received, then provisional navigation data can be created based on the current position obtained by the autonomous navigation.

The ROM 12 stores a variety of programs to be executed by the CPU 11, and stores initial setting data. Such data stored in the ROM 12 includes a navigation program 12a for executing the navigation.

Moreover, the RAM 13 provides a working memory space to the CPU 11, and stores temporal data for work.

The storage unit 14 is a nonvolatile memory that is readable and writable, and for example, is a flash memory or an electrically erasable and programmable read only memory (EEPROM). In this storage unit 14, map data 14a to be used at the time of executing the navigation is stored (map data storage unit). With regard to this map data 14a, it is possible to obtain update data and additional data from the outside through the RF transceiver circuit 22 and the Bluetooth module 24. Moreover, this map data 14a includes map information of underground passages in underground markets, and further, can include height information of buildings and structures such as high-rise buildings, pedestrian decks and viaducts. Based on these pieces of information, the CPU 11 is made capable of determining, in the navigation program 12a, whether or not it is possible to observe such a calculated orientation of each of the GPS satellites from the current position and a spot in the vicinity thereof, that is, it is possible to receive the radio wave from the GPS satellite concerned.

Moreover, in this storage unit 14, GPS satellite orbit data 14b is stored, which is for selecting the GPS satellite from which data is to be received or for setting a receiving frequency in the event of receiving the data from the GPS satellite. This GPS satellite orbit data 14b is obtained in the event of receiving the data from the GPS satellite by the GPS data reception processing unit 26.

The operation unit 15 includes a plurality of operation keys, and converts an input made thereto into an electrical signal based on an operation which the user performs for the keys concerned, and outputs the electrical signal as an input signal to the CPU 11. Alternatively, this operation unit 15 may include a touch panel, and an operation input detection unit of the touch panel.

The built-in timepiece 16 is a counter that counts and holds the current time. This current time is read out, and is then displayed on the display unit 17. Moreover, data of the current time concerned and setting time data related to a variety of functions are compared with each other, whereby a variety of functions are performed, and so on. As an occasion arises, the data of the current time of this built-in timepiece 16 is corrected at the time of communicating with the base station of the cellular phones by the RF transceiver circuit 22. Moreover, it is also possible to correct the data of the current time of this built-in timepiece 16 based on time data obtained in combination in the event where the navigation operation is performed by the GPS data reception processing unit 26.

The display unit 17 is, for example, a liquid crystal display (LCD). By a control signal sent from the CPU 11, the driver 18 (liquid crystal driver) operates, and allows the LCD to make display regarding the variety of functions of the cellular phone 10. This display unit 17 may be another display unit, for example, an organic electro-luminescent display (ELD), and the driver 18 is selected as appropriate depending on a type of the display unit 17.

The speaker 19 converts an electrical signal into an audio signal based on a signal from the codec 21, and then outputs audio. Moreover, the microphone 20 senses an acoustic wave, converts the acoustic wave into an electrical signal, and outputs the electrical signal to the codec 21. The codec 21 decodes a digital audio signal subjected to compression coding, then sends the decoded audio signal as an analog signal to the speaker 19, and in addition, encodes an audio signal obtained from the microphone 20, and then outputs the encoded audio signal to the CPU 11 and the communication circuit 23.

The RF transceiver circuit 22 performs transmission/reception processing for the communication to be performed with the cellular phone base station by using such an RF transmitting/receiving antenna AN11. Moreover, the communication circuit 23 performs a variety of processing for transmission/reception data to be transmitted/received by the RF transceiver circuit 22, and transfers the data with the CPU 11 and the codec 21.

The Bluetooth module 24 is a control module for performing the Bluetooth communication with an external instrument such as the electronic timepiece 40 through the antenna AN12. Transmission data sent from the CPU 11 is subjected to processing such as serial/parallel conversion by the UART 25, and is transmitted to the external instrument from the Bluetooth module 24. Moreover, reception data received from the external instrument by using the Bluetooth module 24 is subjected to processing such as the serial/parallel conversion by the UART 25, and is outputted to the CPU 11.

For example, the GPS data reception processing unit 26 receives radio waves, which come from a plurality of the GPS satellites, through the antenna AN13 for receiving the radio waves transmitted from the GPS satellites. Then, the GPS data reception processing unit 26 demodulates (inverse spectrum spread) radio signals, which are received from the GPS satellites, then decodes the radio signals, obtains time data and position data of the respective satellites, and calculates the current position of the cellular phone 10 based on these data. It is possible to perform an initial setting in advance for the GPS satellites serving as reception subjects and the receiving frequency based on the GPS satellite orbit data 14b. Moreover, a format of the output data is selectable from among formats, which are set to be capable of being outputted in the GPS data reception processing unit 26, by a control signal from the CPU 11.

Though not being particularly limited, this GPS data reception processing unit 26 is composed of a one-chip IC, and has a receiver circuit including a CPU and a memory, which are dedicated for the reception processing. Moreover, this GPS data reception processing unit 26 is capable of independently turning on/off a power supply thereof by a control command of the CPU 11.

The acceleration sensor 27 is a semiconductor sensor capable of detecting accelerations in three axis directions. Based on output data of this acceleration sensor 27, the CPU 11 can specify the gravitational acceleration direction, that is, the downward direction, and the traveling direction.

Moreover, the orientation sensor 28 is, for example, a three-axis geomagnetic sensor using a magnetoresistive element. Based on an output of this orientation sensor 28, the CPU 11 can specify the orientation and the attitude of the cellular phone 10.

Furthermore, a movement orientation of the user is identified by combining output results of the acceleration sensor 27 and the orientation sensor 28.

In the cellular phone 10, the CPU 11 decides the movement orientation based on the output results of the acceleration sensor 27 and the orientation sensor 28. Moreover, for example, a movement amount of the cellular phone 10 is calculated by multiplying a movement time by a predetermined movement speed taken as a coefficient, and the movement amount is added to coordinates of an absolute position serving as a reference, whereby the current position can be estimated autonomously. These acceleration sensors 27, orientation sensor 28 and CPU 11 compose a movement orientation detection unit.

Next, a description is made of the navigation operation in the navigation system of this embodiment.

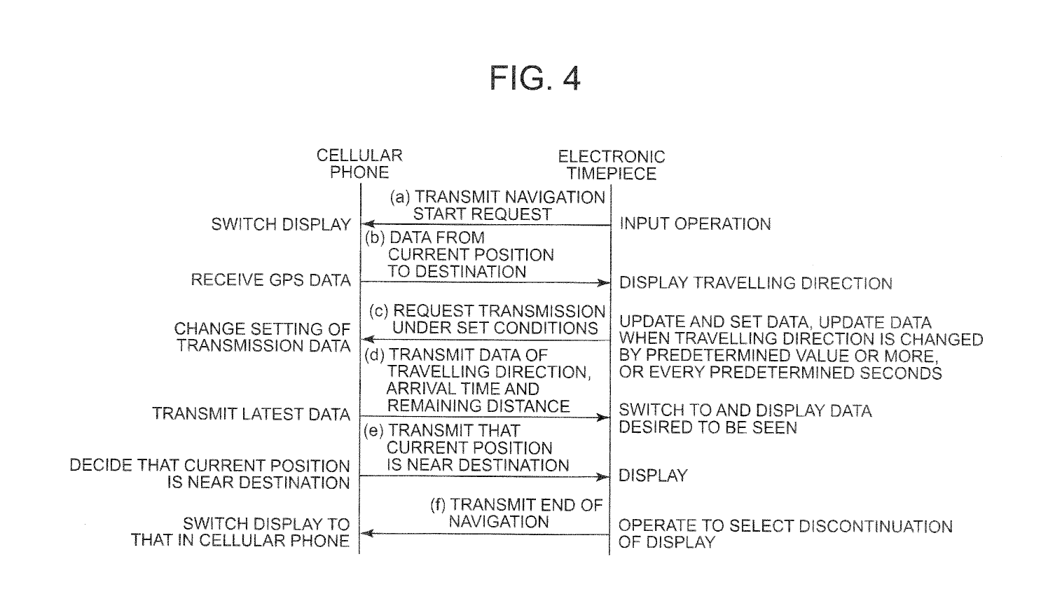

FIG. 4 is a sequence chart showing a procedure of communication to be performed between the cellular phone 10 and electronic timepiece 40 of the navigation system.

Between the cellular phone 10 and electronic timepiece 40 of this embodiment, a communication link for the Bluetooth communication is always maintained in the case where these instruments operate at positions close to each other, where the Bluetooth communication is possible. Moreover, starting and ending of the navigation processing and a setting of a destination and the like are performed in the cellular phone 10, and according to needs, transmission of the navigation data is requested from the electronic timepiece 40 to the cellular phone 10.

First, when an input operation is performed in the electronic timepiece 40, and the navigation in the electronic timepiece 40 is started, then a navigation start request is sent from the electronic timepiece 40 to the cellular phone 10(a). Then, in the cellular phone 10, there is performed processing for switching navigation display from the display unit 17 of the cellular phone 10 to the display unit 46 of the electronic timepiece 40. Then, the radio waves are received from the plurality of GPS satellites, and based on the position data of the GPS satellites and on time difference information regarding reception timing of data from the respective GPS satellites, data related to the current position and a navigation route is obtained. Then, the cellular phone 10 transmits the navigation data to the electronic timepiece 40(b). The electronic timepiece 40 that has received the navigation data displays, on the display unit 46, information selected from the navigation data. At this time, the cellular phone 10 is set so as not display the navigation data thereon, whereby power consumption of the cellular phone 10 can be suppressed.

When timing of updating the set navigation information comes, the electronic timepiece 40 makes a request for the updated navigation data to the cellular phone 10(c). Moreover, at this time, in the case where the setting of the requested navigation data is changed, the electronic timepiece 40 issues a notice on such change to the cellular phone 10. Here, it is possible to set a reception interval of the GPS data and an update interval of the navigation information in the cellular phone 10 separately from a transmission interval thereof to the electronic timepiece 40. In matching with a setting change request from the electronic timepiece 40, the cellular phone 10 changes and sets an output form of the navigation information.

In matching with the setting requested by the electronic timepiece 40, the cellular phone 10 transmits navigation date, which is the latest at this point of time, to the electronic timepiece 40(d). Alternatively, the cellular phone 10 may transmit navigation data obtained for the first time after the update of the navigation information is requested from the electronic timepiece 40. Based on the received navigation data, the electronic timepiece 40 updates the navigation information to be displayed on the display unit 46.

Note that, in the electronic timepiece 40, in the case of displaying only a part of the received navigation data on the display unit 46, it is possible to switch the display contents in accordance with the operation of the user as an occasion arises.

The communication related to the sequences (c) and (d) is repeatedly performed every time when the update request (c) for the navigation information is made from the electronic timepiece 40.

When the current position approaches an inside of a predetermined distance range from the destination of the navigation, the cellular phone 10 transmits, to the electronic timepiece 40, a signal indicating that the user is in the vicinity of the destination (e). Upon receiving this signal, the electronic timepiece 40 performs, on the display unit 46, display showing that the user is in the vicinity of the destination. Then, when a selection to end the navigation display on the electronic timepiece 40 is made based on an input operation of the user, the electronic timepiece 40 transmits an end command to the cellular phone 10(f). Receiving this end command, the cellular phone 10 ends the transmission of the navigation data to the electronic timepiece 40, and switches the display to the display unit 17 of the cellular phone 10.

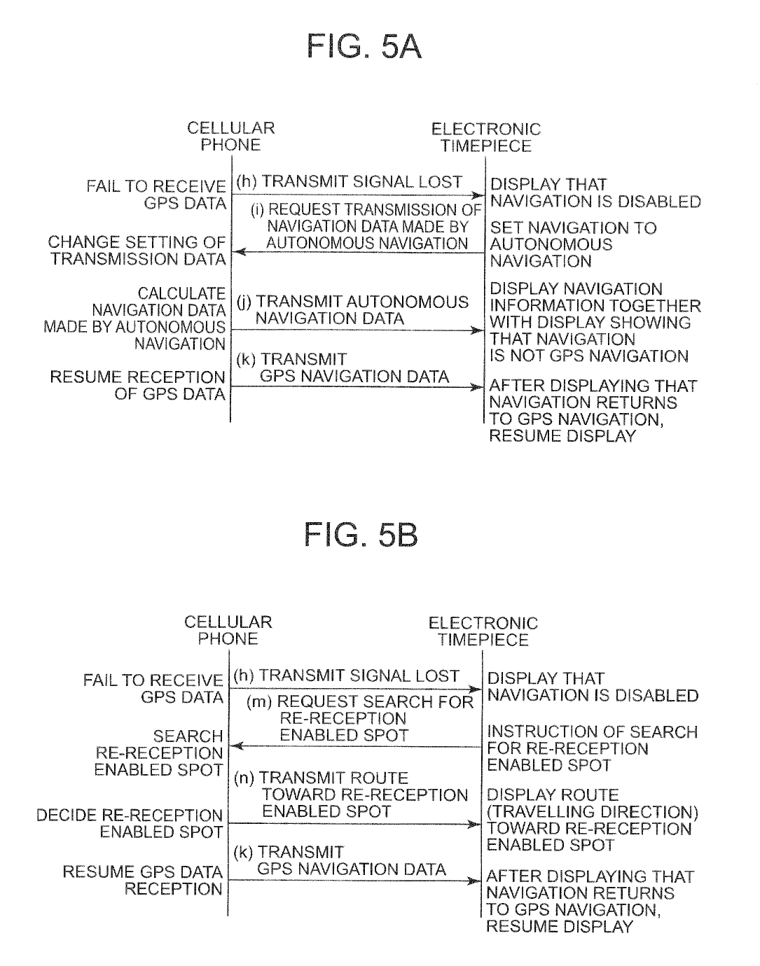

FIG. 5A and FIG. 5B are sequence charts showing examples of procedures of communication to be performed between the cellular phone and the electronic timepiece in a case where the cellular phone fails to receive the radio waves from the GPS satellites during the navigation operation.

When the user of the cellular phone moves to the underground, moves behind the building, and so on, it becomes impossible for the user to receive the radio waves from the GPS satellites. Accordingly, in the case where the cellular phone repeatedly fails for a predetermined time to receive the radio waves from the GPS satellites, it is determined that the user is present at a place where the radio waves from the GPS satellites cannot be received, and communication processing and operations, which are different from those at a usual time, are performed.

First, as shown in FIG. 5A, when the cellular phone 10 fails to receive the GPS data, a signal LOST indicating the failure is transmitted from the cellular phone 10 to the electronic timepiece 40(h). Upon receiving this signal LOST, the electronic timepiece 40 discontinues the navigation display, and allows the display unit 46 to make display showing that the navigation by the GPS cannot be performed. Moreover, on the display unit 46, display for selecting alternatives is made.

Here, in the case where, from among the displayed alternatives, the following action is selected, which is to perform the navigation provisionally (autonomous navigation) by autonomously measuring the data of the current position by using the acceleration sensor 27 and the orientation sensor 28, then a request for navigation data by the autonomous navigation is transmitted from the electronic timepiece 40 to the cellular phone 10(i). Upon receiving the request for the navigation data by the autonomous navigation, the cellular phone 10 switches the setting from such an output state of the signal LOST to the output of the navigation data by the autonomous navigation. Then, the cellular phone 10 transmits the navigation data, which is calculated at a predetermined interval, to the electronic timepiece 40(j). In the event of displaying the received navigation data, the electronic timepiece 40 allows, in combination therewith, display of a mark indicating that the navigation is not the one made by the GPS.

Here, from the acceleration sensor 27 and the orientation sensor 28, which are used for the autonomous navigation, preferably, the navigation data by the autonomous navigation is started to be obtained instantaneously in the event where the cellular phone fails to receive the GPS data, or alternatively, simultaneously with the obtainment of the GPS data at the point of time when the navigation is started. It is also possible to activate the obtainment of the navigation data, which is made by the autonomous navigation, after receiving the request for the data by the autonomous navigation from the electronic timepiece 40. However, in the case where a time lag occurs during a period from the failure of the reception of the GPS data until the obtainment of the data from the acceleration sensor 27 and the orientation sensor 28, it becomes impossible to measure the movement distance and the movement direction during that period, and accuracy of the calculated position data is lowered.

Moreover, in the autonomous navigation, as a movement time becomes longer, an error also becomes cumulatively larger. Accordingly, for example, in the case where the navigation by the autonomous navigation continues for a predetermined time or more, the navigation display may be discontinued.

When the reception of the GPS data is resumed by the cellular phone 10, the cellular phone 10 creates navigation data based on the received GPS data. Then, after transmitting, to the electronic timepiece 40, a signal indicating that the display will be switched to that of the GPS navigation information, the cellular phone 10 transmits the created navigation data thereto (k). Upon receiving these signal and navigation data, the electronic timepiece 40 makes display showing that the display will return to that of the GPS navigation, and thereafter, resumes the display of the navigation data together with a mark indicating that the current navigation is the GPS navigation.

Meanwhile, FIG. 5B shows a sequence chart explaining another display example selectable on the electronic timepiece 40 side in the case where the cellular phone 10 fails to receive the GPS data, and the signal LOST is transmitted therefrom.

First, in a similar way to the example shown in FIG. 5A, the signal LOST, which indicates that the cellular phone 10 fails to receive the GPS data, is transmitted from the cellular phone 10 concerned to the electronic timepiece 40(h). Upon receiving this signal LOST, the electronic timepiece 40 discontinues the navigation display, and allows the display unit 46 to make display showing that the navigation by the GPS cannot be performed. Moreover, on the display unit, display for selecting alternatives is made simultaneously.

Here, in the case where the user desires that the GPS navigation be resumed rapidly, then the user can select a request to allow the detection of a close spot where it is possible to receive the GPS data again (that is, a re-reception enabled spot) from among the alternatives displayed on the display unit 46 of the electronic timepiece 40. Then, based on this request, a search request signal for the re-reception enabled spot is transmitted from the electronic timepiece 40 to the cellular phone 10(m).

Upon receiving the search request signal from the electronic timepiece 40, the cellular phone 10 searches the spot where it is possible to receive the radio waves from the GPS satellites again in the vicinity of the current position. For example, in the case where the current position is the underground passage, then the cellular phone 10 searches an exit to the ground, which is located nearby. Moreover, at such a spot behind the high-rise building, the cellular phone 10 searches a spot, which goes from behind the building, based on the height information of the building in the map data 14a and on the position information of the GPS satellites from which the reception is attempted. Then, the cellular phone 10 decides a route toward the searched re-reception enabled spot, and transmits information of the route concerned to the electronic timepiece 40(n).

Upon receiving the route information toward the re-reception enabled spot, the electronic timepiece 40 allows the display unit 46 to display the route information toward the spot concerned. At this time, in the case where the navigation by the autonomous navigation is not performed during the guide of the route, then the electronic timepiece 40 allows the display unit 46 to display, in a lump, the information of the moving direction and distance to the re-reception enabled spot. In the case where the navigation to the re-reception enabled spot is performed by the autonomous navigation, then the destination of the navigation may be temporarily changed to the obtained re-reception enabled spot, and the information of the route toward the re-reception enabled spot may be transmitted from the cellular phone 10 to the electronic timepiece 40 at a predetermined time interval.

When the cellular phone 10 succeeds in receiving the GPS data again, the cellular phone 10 updates the navigation data based on the GPS data concerned. Then, the cellular phone 10 transmits the signal, which indicates that the display has returned to the GPS navigation, to the electronic timepiece 40, and thereafter, resumes the requested transmission of the navigation data (k). Upon receiving these signal and navigation data, the electronic timepiece 40 allows display showing that the display will return to the navigation by the GPS, and thereafter, resumes the display of the navigation data together with a mark indicating that the navigation is the one made by the GPS.

Next, a description is made of an operation procedure of the navigation display in the electronic timepiece 40.

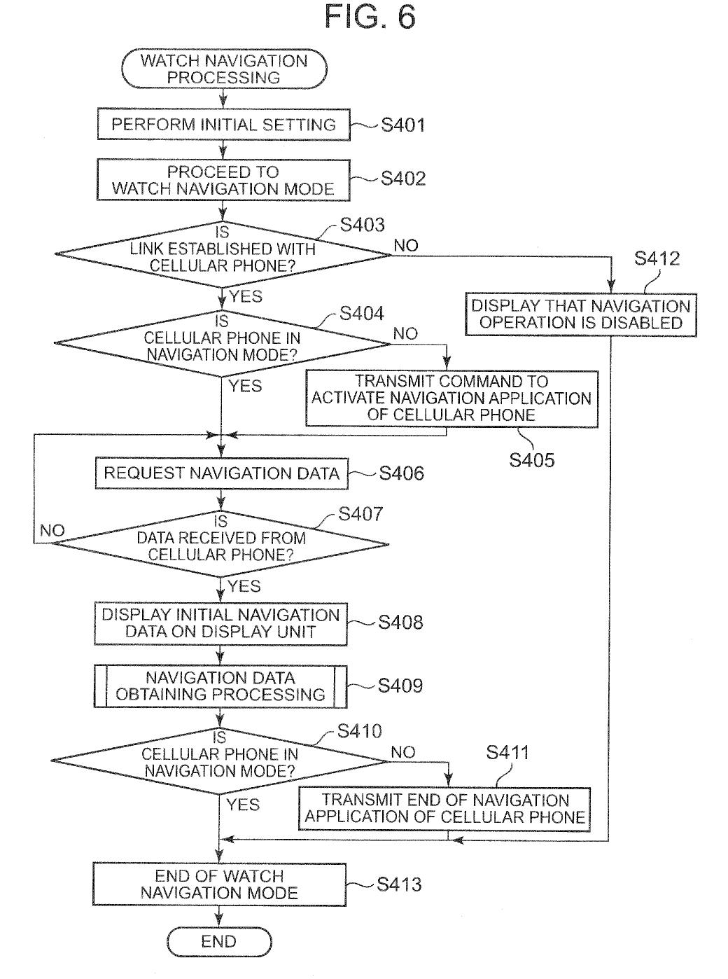

FIG. 6 is a flowchart showing a control procedure of such watch navigation processing by the CPU, which is to be executed in the electronic timepiece.

This watch navigation processing is processing to be started based on an input operation to the operation unit 44 by the user of the electronic timepiece 40. When an input signal for starting the watch navigation processing is detected from the operation unit 44, and the watch navigation processing is started, then the CPU 41 first performs an initial setting of the watch navigation processing (Step S401). In this initial setting, there are performed: a setting of display contents on the electronic timepiece 40, and such a setting of an interval at which the update of the navigation information is requested to the cellular phone 10. These setting data are stored as navigation setting data, for example, in the RAM. 43. Moreover, it is also possible to newly set these setting data by an input operation from the operation unit 44 at the time when the navigation is started, and to change the setting data thereby.

Next, the CPU 41 shifts the display, which is to be made on the display unit 46, to a watch navigation mode (Step S402). Specifically, for example, a size of the time display is reduced, and in addition, on a space thus made, the information of the moving direction, the moving distance and the like is displayed.

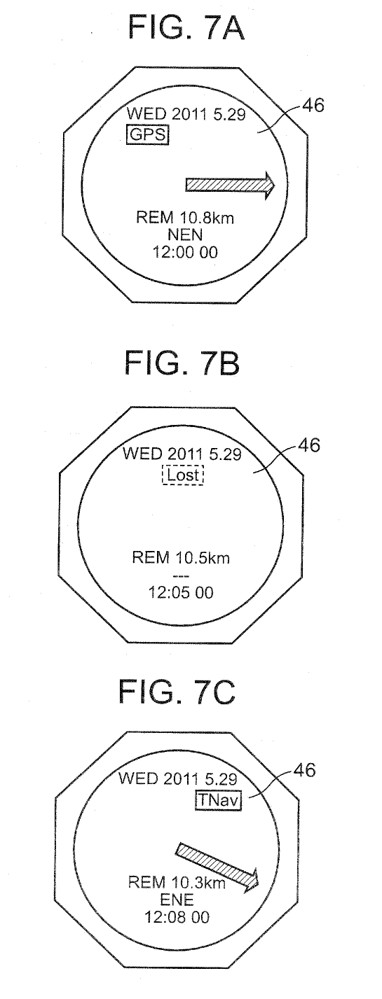

FIG. 7A to FIG. 7C show display examples on the display 46 of the electronic timepiece 40 in the watch navigation mode.

As shown in FIG. 7A, during the execution of the navigation using such GPS positioning data, on an upper portion and lower portion of the display unit 46, the date and the current time are displayed to be small, respectively, and on a portion below display of the date, a mark “GPS” indicating that the current navigation is performed under a GPS navigation mode is turned on. Moreover, “N”, “E” and “N”, which sequentially indicate the orientations corresponding to such movement directions toward the destination, are displayed together with display “REM 10.8 km” indicating a remaining movement distance. More specifically, “N” indicates the orientation of the current movement direction, “E” indicates the orientation of the next movement direction, and “N” indicates the orientation of the subsequent movement direction. Furthermore, an actual travelling direction with respect to the display unit 46 is displayed by one arrow. Note that the display of this arrow and the display of the letters and the numbers are able to be displayed in a stacked manner.

Subsequently, the CPU 41 determines whether or not the communication link is established between the cellular phone 10 and the electronic timepiece 40 (Step S403). Between the cellular phone 10 and the electronic timepiece 40 in this embodiment, the communication link is always established in the case where both thereof operate within the distance where the Bluetooth communication is possible. Accordingly, in the case where the communication link is not established, it is determined that the cellular phone 10 is not located nearby, or that the operation thereof is stopped. Hence, in the case where it is determined that the communication link is not established, then the CPU 41 allows the display unit 46 to display that the navigation operation cannot be performed (Step S412). As shown in FIG. 7B, in the event of this display, the CPU 41 allows, for example, blinking display of a mark “Lost”, thereby indicating that the navigation cannot be performed. Moreover, in the event of this display, the arrow is not displayed. Then, the processing of the CPU 41 proceeds to Step S413.

In the case where, in such determination processing of

Step 5403, it is determined that the communication link with the cellular phone is established, then subsequently, the CPU 41 determines whether or not the cellular phone 10 is in the navigation mode (Step S404). Specifically, the CPU 41 transmits a confirmation request to the cellular phone 10, and from the cellular phone 10, obtains information as to whether or not the navigation program 12a is under execution. In the case where it is determined that the navigation program 12a is under execution, the processing of the CPU 12 directly proceeds to Step 5406. In the case where it is determined that the navigation program 12a is not under execution, the CPU 41 transmits, to the cellular phone 10, a command to activate a program of a navigation application (Step S405). This program of the navigation application may be the same as the navigation program 12a, or may be a restrictive program to be executed only in the case of transmitting the navigation data from the cellular phone 10 to the electronic timepiece 40. Note that, in such a navigation application program activated in the cellular phone 10, in the case where the destination is not set, then the destination is set by the input operation to the operation unit 15 of the cellular phone 10.

At this time, the CPU 41 stores, in the RAM. 43, the matter that the cellular phone 10 is not in the navigation mode at the point of time when the watch navigation processing is started in the electronic timepiece 40. Then, the processing of the CPU 41 proceeds to Step S406.

After proceeding to processing of Step S406, the CPU 41 transmits, to the cellular phone 10, a signal for requesting the navigation data. At this time, in combination therewith, the CPU 41 transmits such setting information as a format of the navigation data requested to the cellular phone 10. Then, within a predetermined time, the CPU 41 stands by for the reception of the navigation data from the cellular phone 10. When the data is received from the cellular phone 10 within the predetermined time, or when the predetermined time elapses while the reception of the data from the cellular phone 10 is being left undone, the CPU 41 determines whether or not the desired navigation data is completely obtained from the cellular phone 10 (Step S407). Then, in the case where it is determined that the desired navigation data is not obtained, the processing of the CPU 41 branches off to “NO”, and returns to Step S406, where the signal for requesting the navigation data is transmitted to the cellular phone 10 again. In the case where it is determined that the desired navigation data is obtained, the processing of the CPU 41 branches off to “YES” in the determination processing of Step S407.

When the processing of the CPU 41 branches off to “YES” in the determination processing of Step S407, the CPU 41 decides contents, which are to be first displayed on the display unit 46, based on the obtained navigation data, and allows the display unit 46 to display the same (Step S408). Subsequently, the processing of the CPU 41 proceeds to navigation data obtaining processing to be described later, and the CPU 41 allows the display unit 46 to display the navigation data while updating the same (Step S409).

When the navigation data obtaining processing is ended, the CPU 41 determines whether or not the cellular phone 10 is in the navigation mode in the event where the watch navigation processing is started (Step S410). Specifically, the CPU 41 accesses the RAM 43, and investigates whether or not, in the processing of Step S404, in the RAM 43, there is stored that the cellular phone 10 is not in the navigation mode in the event where the watch navigation processing is started. In the case where it is determined that the cellular phone 10 is not in the navigation mode, then the CPU 41 transmits, to the cellular phone 10, a request to end the navigation application (Step S411). Then, the processing of the CPU 41 proceeds to Step S413. In the case where it is determined that the cellular phone 10 is in the navigation mode from the point of time when the watch navigation processing is started, the processing of the CPU 41 directly proceeds to Step S413.

After the processing of the CPU 41 proceeds to processing of Step S413, the CPU 41 ends such a watch navigation mode. The CPU 41 switches the display contents on the display unit 46 to those in a mode before entering the watch navigation mode. Alternatively, the display unit 46 may be allowed to make menu display of the Bluetooth communication. Then, the watch navigation processing is ended.

Next, a description is made of the navigation data obtaining processing to be called up in the watch navigation processing.

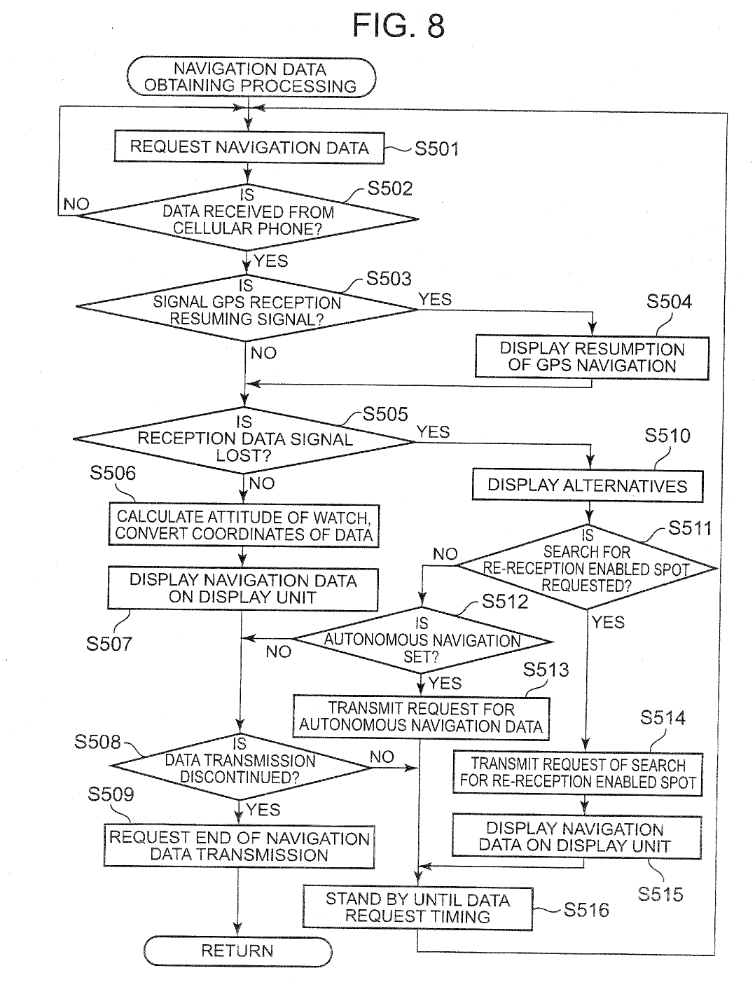

FIG. 8 is a flowchart showing a procedure of control to be executed by the CPU in the event of the navigation data obtaining processing.

After proceeding to the navigation data obtaining processing, the CPU 41 transmits, to the cellular phone 10, the signal for requesting the navigation data (Step S501). In the case of changing the format of the requested navigation data in midstream, then in combination therewith, the CPU 41 transmits thereto the setting information that is changed. Then, for a predetermined time, the CPU 41 stands by for the reception of the navigation data from the cellular phone 10. When the data is received from the cellular phone 10 within the predetermined time, or when the predetermined time elapses while the reception of the data from the cellular phone 10 is being left undone, then the CPU 41 determines whether or not the data transmitted from the cellular phone 10 is obtained completely (Step S502). Then, in the case where it is determined that the transmission data is not obtained completely, the processing of the CPU 41 branches off to “NO”, and returns to Step S501, where the CPU 41 transmits the signal for requesting the navigation data to the cellular phone 10 again. In the case where it is determined that the transmission data is obtained completely, the processing of the CPU 41 branches off to “YES” in the determination processing of Step S502.

When the processing of the CPU 41 branches off to “YES” in the determination processing of Step S502, then the CPU 41 determines whether or not the obtained data is a “GPS reception resuming signal”. In the case where it is determined that the obtained data is the GPS reception resuming signal, the CPU 41 allows the display unit 46 to make display showing the resumption of the GPS navigation, and changes the setting to the GPS navigation mode that is usual (Step S504). Then, the processing of the CPU 41 proceeds to Step S505. In the case where it is determined that the obtained data is not the GPS reception resuming signal, the processing of the CPU 41 directly proceeds to Step S505.

After proceeding to processing of Step S505, the CPU 41 subsequently determines whether or not the obtained data is the signal LOST indicating the failure of the GPS data reception. In the case where it is determined that the obtained data is not the signal LOST, the CPU 41 determines that the navigation data is obtained, and proceeds to processing of Step S506. The CPU 41 obtains the output signals from the acceleration sensor 54 and the orientation sensor 55, and identifies the attitude of the electronic timepiece 40. Then, based on the identified attitude of the electronic timepiece 40 and on the data of the travelling direction in the navigation data obtained at this time, the CPU 41 calculates the travelling direction on the display unit 46 of the electronic timepiece 40. The CPU 41 allows the display unit 46 to display thereon the arrow indicating this travelling direction and the number and letter data indicating other travelling directions and movement distances (Step S507).

Then, the processing of the CPU 41 proceeds to Step S508.

Meanwhile, in the case where, in the determination processing of Step S505, it is determined that the reception data is the signal LOST, the CPU 41 discontinues the navigation display onto the display unit 46, and allows the display unit 46 to display the alternative of the case where the navigation data cannot be displayed on the display unit 46 (Step S510). Then, the CPU 41 stands by for the input operation from the user.

Note that, in the case where the reception of the GPS data is resumed during such standby of the CPU 41, then the GPS reception resuming signal is transmitted from the cellular phone 10 to the electronic timepiece 40, and the CPU 41 detects this GPS reception resuming signal, and is capable of making a setting, for example, so that the processing can skip to Step S504 by interruption processing.

Moreover, in the case where the signal LOST is received once and the setting change is made to the navigation by the autonomous navigation to be described later, then the reception data until the GPS reception is resumed is the navigation data by the autonomous navigation. In this case, the determination processing of Step S505 branches off to “NO”, and the CPU 41 executes processing on and after Step S506 based on the navigation data by the autonomous navigation.

When the input operation from the user is sensed, the CPU 41 first determines whether or not the input operation is the search request for the re-reception enabled spot (Step S511). In the case where it is determined that the input operation is the search request for the re-reception enabled spot, then the CPU 41 transmits such a re-reception enabled spot search request to the cellular phone 10 (Step S514). Then, the CPU 41 allows the display unit 46 to display the navigation data to the re-reception enabled spot, which is transmitted from the cellular phone 10 in accordance with such a signal of the request (Step S515). Then, the processing of the CPU 41 proceeds to processing of Step S516, and in this case, the processing of the CPU 41 turns to a standby state until the GPS reception resuming signal is sensed.

In the case where, in the determination processing of Step S511, it is determined that the input operation is not the search request for the re-reception enabled spot, the CPU 41 next determines whether or not the input operation is a request for the setting change to the navigation by the autonomous navigation (Step S512). In the case where it is determined that the input operation is the request for the setting change to the navigation by the autonomous navigation, then the CPU 41 transmits, to the cellular phone 10, the request for the setting change to the navigation by the autonomous navigation (Step S513). Then, the processing of the CPU 41 proceeds to processing of Step S516, and in this case, the processing of the CPU 41 turns to the standby state until the update timing of the navigation data. At this time, as shown in FIG. 7C, a mark “TNav”, which indicates that the current navigation mode is the autonomous navigation navigation mode that is not the GPS navigation, is turned on by the CPU 41.

In the case where, in the determination processing of Step S512, it is determined that the input operation is not the request for the setting change to the navigation by the autonomous navigation, the processing of the CPU 41 proceeds to Step S508.

After proceeding to processing of Step S508, the CPU 41 determines whether or not a command to discontinue a receiving operation for the navigation data from the cellular phone 10 is sensed. In the case where it is determined that such a request to discontinue the reception of the navigation data, which is made owing to the input operation to the operation unit 44 when the navigation system reaches a destination spot or fails to receive the GPS data, owing to a decrease of battery power, and so on, is detected, then the CPU 41 transmits, to the cellular phone 10, a request to end the transmission of the navigation data (Step S509). Then, the processing of the CPU 41 returns to the watch navigation processing.

In the case where, in the determination processing of Step S508, it is determined that the request to discontinue the reception of the navigation data is not sensed, then the processing of the CPU 41 proceeds to Step S516. Then, in this case, the CPU 41 stands by until the elapse of a time interval set as timing of requesting the navigation data for the next time, or until a set situation comes.

At the time of determining that the timing of requesting the data elapses in Step S516, the CPU 41 returns the processing to Step S501, requests the next navigation data to the cellular phone 10, and repeats the navigation data obtaining processing.

As described above, in accordance with the navigation system 1 and the electronic timepiece 40 in this embodiment, the communication function by Bluetooth is provided, the GPS navigation function of the cellular phone 10 is operated, and only the navigation data is obtained by the Bluetooth communication, whereby the simple navigation data can be displayed on the display unit 46. Hence, even in a state where there is no free hand in the case where the user is holding baggage by both hands or is riding a bicycle, the user can easily obtain the navigation information through the watch. That is to say, while effectively using the advantages of the electronic timepiece 40 as a wrist-attached terminal, the user can use the function of the cellular phone 10 in an auxiliary manner.

Moreover, the electronic timepiece 40 does not include the GPS navigation operation in the operations of its own. In such a way, the electronic timepiece 40 does not have to perform operations which require large electric power, and can achieve cost reduction and size miniaturization. Furthermore, the electronic timepiece 40 takes over the display function of the cellular phone 10, thereby reduces the processing in the cellular phone 10, and can suppress the power consumption thereof.

Furthermore, the electronic timepiece 40 includes the orientation sensor 55, and can thereby display the navigation data, which is obtained from the cellular phone 10, in response to the attitude of the electronic timepiece 40 itself. Accordingly, the electronic timepiece 40 can provide the navigation information simply without lowering convenience for the user.

Moreover, in this navigation system 1, the simple navigation data is displayed on the electronic timepiece 40 only when necessary by the input operation to the operation unit 44 of the electronic timepiece 40, and in the case where the hands are free at a break time and so on, complete navigation data can be displayed on the display unit 17 of the cellular phone 10. Accordingly, the user can get to know a necessary amount of the navigation information according to needs.

Moreover, in the case where the cellular phone 10 enters a place where the cellular phone 10 cannot receive the radio waves from the GPS satellites, then based on the map data, this navigation system 1 can search the neighboring spot where it is possible to receive the radio waves from the GPS satellites again, and can obtain and display the route information from the place where the current position is obtained the last time to the spot where such re-reception is possible. Accordingly, in such a place where the user gets lost without the GPS navigation information, the navigation system 1 can continue the GPS navigation with ease.

Moreover, in this navigation system 1, in particular, the map data held by the cellular phone 10 is allowed to include the maps of the underground markets and the underground passages and the data of the buildings in the height direction. In such a way, it also becomes possible to easily search the spot where it is possible to receive the radio waves from the GPS satellites, and to show the route toward the exit from the underground market.

Moreover, in the case where the cellular phone 10 becomes incapable of creating the navigation data by the GPS positioning, then by using the orientation sensor and the acceleration sensor, this navigation system 1 calculates a relative movement vector from the spot where the GPS positioning is performed the last time, obtains the current position data provisionally, and can thereby continue the navigation for a while. Therefore, the navigation system 1 can also cope with the underground markets and tunnels easily.

Furthermore, the cellular phone 10 updates the navigation data at the predetermined interval, and maintains the accuracy of the navigation information so that the accuracy cannot drop. In addition, the electronic timepiece 40 can make the setting so as to obtain the navigation data from the cellular phone 10 only in the case where the current conditions coincide with predetermined conditions such as a time when the user reaches a crossing and a situation where the user is at a corner on a street. Accordingly, the user can be prevented from having difficulty visually recognizing the information in a short time on the contrary owing to the fact that the display is updated more than necessary during the movement, the battery power can be prevented from being consumed owing to the same fact, and so on.

Note that the present invention is not limited to the above-described embodiment, and is modifiable in various ways.

For example, in the above-described embodiment, the electronic watch is mentioned as the wrist-attached terminal; however, the wrist-attached terminal may be others as long as such a short-range wireless communication unit and such a display unit capable of displaying a necessary amount of the navigation data are provided. For example, an electronic pedometer and the like may be used.

Moreover, the cellular phone is mentioned as an example of the portable external instrument; however, the present invention is applicable to a portable one provided with the GPS positioning function and the short-range wireless communication unit. For example, a variety of electronic instruments such as a smart phone and a personal digital assistant (PDA) can be used. Moreover, the navigation program is installed in varieties of the wrist-attached terminals and the electronic instruments, whereby a navigation system in which the variety of devices are combined with one another can be configured.

Moreover, the above embodiment has been described by taking the Bluetooth communication as an example; however, other short-range wireless communication units are also usable, which are in accordance with the infrared communication, ZIGBEE (registered trademark), Ultra Wide Band (UWB), and the like.

Moreover, the above embodiment has been described by taking the GPS satellites as examples of the positioning satellites; however, the positioning may be performed by receiving radio waves from satellites of another global navigation satellite system (GLASS). Furthermore, in the case where the position information can be obtained by communication between the cellular phone 10 and the base station, the position information concerned may be used in combination.

Moreover, the example has been illustrated, where the route toward the neighboring re-reception enabled spot of the GPS radio waves is displayed in the case where it becomes impossible to receive the radio waves from the GPS satellites; however, a re-reception enabled spot in the direction of the conventional navigation route may be preferentially selected and displayed. Moreover, the navigation toward the re-reception enabled spot may be performed by the autonomous navigation.

Meanwhile, the example has been illustrated, where the navigation is provisionally performed based on the current position data obtained by the autonomous navigation in the case where it becomes impossible to receive the radio waves from the GPS satellites; however, such navigation data by the autonomous navigation may be directly calculated by the CPU 41 of the electronic timepiece 40 by using the outputs of the orientation sensor 55 and the acceleration sensor 54, which are held by the electronic timepiece 40. The electronic timepiece 40 is provided with such a function, whereby the electronic timepiece 40 can complement the navigation function in the case of receiving data from a portable external instrument that is dedicated for the GPS navigation and does have a autonomous navigation function.

Moreover, in the above-described embodiment, the cellular phone 10 is provided with both of the GPS positioning function and the navigation data creation function; however, such a configuration may be adopted, in which an external server or the like is allowed to include more detailed map data, and to execute the creation of the navigation data based on the GPS positioning data, and the cellular phone 10 is allowed to obtain the navigation data through the wireless communication or a cellular phone line.

Moreover, the acceleration sensor has been mentioned as an example of the unit that detects the movement direction; however, other measurement instruments such as a gyro sensor may be used.

Moreover, in the above description, there is disclosed the example of using the ROM 42 as a computer readable medium for the program according to the present invention; however, the computer readable medium is not limited to this example. As other computer readable mediums, it is possible to apply a nonvolatile memory such as a flash memory and a portable recording medium such as a CD-ROM. Furthermore, as a medium that provides the data of the program according to the present invention through the communication line, a carrier wave is also applied to the present invention.

Besides the above, details of the configurations and the operations regarding the electronic timepiece 40, the navigation program 42a and the navigation system 1, which are described in the above embodiment, are modifiable as appropriate within the scope without departing from the spirit of the present invention.

What is claimed is:

1. A portable terminal comprising:
a wireless communication unit which performs transmission and reception of data with a portable external instrument by wireless communication;
a control unit which requests navigation data from the portable external instrument at a previously set request timing, and obtains the navigation data from the portable external instrument by using the wireless communication unit;
a display unit which performs a display based on a control signal from the control unit; and
a detection unit which detects an orientation,
wherein the control unit (i) allows the display unit to display orientation information included in the navigation data obtained from the wireless communication unit, in accordance with orientation data obtained based on a signal from the detection unit, and (ii) allows the display unit to display navigation data that is simple in comparison with the navigation data displayed by the portable external instrument, the simple navigation data including at least a display in a travelling direction, based on the navigation data obtained from the portable external instrument by the wireless communication unit.

2. The portable terminal according to claim 1, further comprising:
an operation unit which receives an input operation of a user,
wherein, based on an operation signal from the operation unit, the control unit allows the wireless communication unit to perform a request regarding transmission of the navigation data to the portable external instrument.

3. The portable terminal according to claim 1,
wherein, in a case of obtaining, from the portable external instrument, a signal indicating a reception failure of radio waves from positioning satellites, the radio waves being necessary to create the navigation data, then the control unit obtains, from the portable external instrument, route information toward a position where it is possible to receive again the radio waves from the positioning satellites, and then allows the display unit to display the route information.

4. The portable terminal according to claim 2,
wherein, in a case of obtaining, from the portable external instrument, a signal indicating a reception failure of radio waves from positioning satellites, the radio waves being necessary to create the navigation data, then the control unit obtains, from the portable external instrument, route information toward a position where it is possible to receive again the radio waves from the positioning satellites, and then allows the display unit to display the route information.

5. The portable terminal according to claim 1,
wherein, in a case of obtaining, from the portable external instrument, a signal indicating a reception failure of radio waves from positioning satellites, the radio waves being necessary to create the navigation data, then the control unit obtains provisional navigation data from the portable external instrument, and then allows the display unit to display the provisional navigation data.

6. The portable terminal according to claim 2,
wherein, in a case of obtaining, from the portable external instrument, a signal indicating a reception failure of radio waves from positioning satellites, the radio waves being necessary to create the navigation data, then the control unit obtains provisional navigation data from the portable external instrument, and then allows the display unit to display the provisional navigation data.

7. A navigation system comprising:
a portable external instrument; and
the portable terminal according to claim 1,
the portable external instrument including:
an external wireless communication unit which performs transmission and reception of data with another instrument by wireless communication;
a positioning data receiving unit which receives and decodes radio waves from positioning satellites, and obtains current position data;
a map data storage unit which stores map data;
an input unit which sets and inputs a movement destination; and
a navigation data creation unit which decides a movement route and creates navigation data based on the current position data obtained by the positioning data receiving unit, on the map data, and on the movement destination,
wherein the control unit obtains the navigation data, the navigation data being created by the navigation data creation unit of the portable external instrument, by the wireless communication between the external wireless communication unit and the wireless communication unit, and then allows the display unit to display the simple navigation data.

8. The navigation system according to claim 7,
wherein, in a case where the positioning data receiving unit fails to receive the radio waves from the positioning satellites, then based on the map data, the navigation data creation unit calculates a re-reception enabled spot where it is possible to receive the radio waves from the positioning satellites, and sets route information toward the re-reception enabled spot.

9. The navigation system according to claim 8,
wherein the map data includes map data of underground markets and underground passages, and height data of buildings.

10. A navigation system comprising:
a portable external instrument; and
the portable terminal according to claim 5,
the portable external instrument including:
an external wireless communication unit which performs transmission and reception of data with another instrument by wireless communication;
a positioning data receiving unit which receives and decodes radio waves from positioning satellites, and obtains current position data;
a map data storage unit which stores map data;
an input unit which sets and inputs a movement destination;
a navigation data creation unit which decides a movement route and creates navigation data based on the current position data obtained by the positioning data receiving unit, on the map data, and on the movement destination;
a movement orientation detection unit which detects a movement direction; and
a movement vector calculation unit which calculates a movement amount by using the movement direction, a movement time and a predetermined parameter,
wherein, in a case where the positioning data receiving unit fails to receive the radio waves from the positioning satellites, the navigation data creation unit calculates a current position by adding the movement amount calculated by the movement vector calculation unit to latest current position data obtained by the positioning data receiving unit, and then creates the provisional navigation data.

11. The navigation system according to claim 7,
wherein the navigation data creation unit creates the navigation data at a predetermined interval, and
the control unit requests the navigation data from the portable external instrument only in a case where current conditions coincide with preset conditions.

12. The navigation system according to claim 10,
wherein the navigation data creation unit creates the navigation data at a predetermined interval, and
the control unit requests the navigation data from the portable external instrument only in a case where current conditions coincide with preset conditions.

13. A storage medium which stores a program which allows a computer, including a wireless communication unit performing transmission and reception of data with a portable external instrument by wireless communication; a display unit; and a detection unit which detects an orientation, to function as:
a control unit which requests navigation data from the portable external instrument at a previously set request timing, and obtains the navigation data from the portable external instrument by using the wireless communication unit,
wherein the control unit executes processing for (i) allowing the display unit to display orientation information included in the navigation data obtained from the wireless communication unit, in accordance with orientation data obtained based on a signal from the detection unit, and (ii) allowing the display unit to display navigation data that is simple in comparison with the navigation data displayed by the portable external instrument, the simple navigation data including at least a display in a travelling direction, based on the navigation data obtained from the portable external instrument by the wireless communication unit.
